(19) United States
(12) Patent Application Publication
(10) Pub. No.: US 2021/0018114 A1
(43) Pub. Date: Jan. 21, 2021

(54) GAS FUSE COCK HAVING FLOW RATE SENSOR EMBEDDED THEREIN AND AUTOMATIC GAS SAFETY CIRCUIT BREAKER INCLUDING SAME

(71) Applicant: SAFETEC CO., LTD., Bucheon (KR)

(72) Inventors: In Kyu KIM, Bucheon (KR); Kang Min LEE, Gimpo (KR)

(73) Assignee: SAFETEC CO., LTD., Bucheon (KR)

(21) Appl. No.: 17/041,446

(22) PCT Filed: Jan. 31, 2019
(86) PCT No.: PCT/KR2019/001367

§ 371 Date: Sep. 25, 2020

(30) Foreign Application Priority Data
Apr. 6, 2018 (KR) 10-2018-0040626

(51) Int. Cl. F16K 37/00; G01F 15/00; G05D 7/06; F16K 17/20

(52) U.S. Cl. CPC F16K 37/005; G01F 15/002; F16K 17/20; G05D 7/0635; G01F 15/005

(57) ABSTRACT

The present invention relates to a gas fuse cock embedded with a flow rate sensor and an automatic gas safety shut-off device having the same, in which a flow rate sensor unit is injection-molded integrally with the gas fuse cock, and the flow rate sensor is mounted to reduce leakage of gas without a separate connecting component, and the present invention provides a gas fuse cock embedded with a flow rate sensor and an automatic gas safety shut-off device having the same, in which the flow rate sensor is directly embedded in a housing of a gas valve without a separate connecting tube, and a connecting portion is eliminated, thereby improving safety against leakage of gas.

### TECHNICAL FIELD

The present invention relates to a gas fuse cock embedded with a flow rate sensor and an automatic gas safety shut-off device having the same, and more particularly, to a gas fuse cock embedded with a flow rate sensor and an automatic gas safety shut-off device having the same, in which the flow rate sensor is mounted to reduce leakage of gas without requiring a separate connecting component.

### BACKGROUND ART

In general, a gas appliance such as a gas stove or a gas heater is connected to a gas supply pipe so as to be supplied with gas from an external gas supply source, and a gas valve is installed in the gas supply pipe to shut off a flow of gas.

A user opens the gas valve to supply the gas before operating the gas appliance and closes the gas valve to shut off a supply of the gas after using the gas appliance.

FIG. 1 illustrates an example of a gas valve used in the related art. As illustrated, the gas valve 10 in the related art has a ball valve 14 provided in a body 11 between a gas inlet port 13 and a gas outlet port 12.

In this case, insulators 15 are provided at both sides of the ball valve 14. In order to mount the insulators 15 on the ball valve 14, a complicated manufacturing process of separately manufacturing the gas outlet port 12 and the body 11, mounting the insulators 15 on the ball valve 14, and then welding the gas outlet port 12 and the body 11 is inevitably required.

In addition, as illustrated in FIG. 1, in the related art, a sensor insertion tube 17 for installing a flow rate sensor 16 is connected between the gas outlet port 12 and the body 11 in order to install the flow rate sensor 16 for detecting leakage of gas in the gas valve 10.

However, there is concern that the gas may leak at a connecting portion between the body 11 and the sensor insertion tube 17 and a connecting portion between the gas outlet port 12 and the sensor insertion tube 17, and as a result, there is a problem in that a complicated sealing operation needs to be separately performed to seal the respective connecting portions.

Meanwhile, as the related art associated with the present invention, there is Korean Patent No. 10-0721932. As illustrated in FIG. 2, according to Korean Patent No. 10-0721932, the separate connection of the sensor insertion tube 17 increases an overall length of the gas valve 10, which causes an increase in number of manufacturing processes, and an increase in manufacturing costs. Further, in a case in which a cover body 18 capable of covering the body 11 of the gas valve 10 is mounted, a volume of the gas valve is increased, which causes a problem of a deterioration in aesthetic appearance.

Accordingly, there is a need for a method of solving the above-mentioned problems.

### DISCLOSURE

### Technical Problem

The present invention has been made in an effort to solve the above-mentioned problems in the related art, and an object of the present invention is to provide a gas fuse cock embedded with a flow rate sensor and an automatic gas safety shut-off device having the same, in which the flow rate sensor is directly embedded in a housing of a gas valve without requiring a sensor insertion tube, thereby improving safety against leakage of gas.

Another object of the present invention is to provide a gas fuse cock embedded with a flow rate sensor and an automatic gas safety shut-off device having the same, in which respective components of a gas valve are integrally injection-molded, thereby eliminating a connecting portion and thus preventing leakage of gas.

Still another object of the present invention is to provide a gas fuse cock embedded with a flow rate sensor and an automatic gas safety shut-off device having the same, which are capable of detecting leakage of gas by using an IoT-based sensor network, and safely, quickly, and remotely shutting off the gas in a dangerous situation.

Technical problems of the present invention are not limited to the aforementioned technical problems, and other technical problems, which are not mentioned above, may be clearly understood by those skilled in the art from the following descriptions.

### Technical Solution

In order to achieve the above-mentioned objects, a gas fuse cock embedded with a flow rate sensor according to the present invention may include: a gas valve unit formed in the form of a housing having a hollow space, having one side connected to a gas supply source, and configured to control a flow of gas; and a tubular flow rate sensor unit having one side connected to a gas appliance, injection-molded integrally with the gas valve unit so as to extend from the other side of the gas valve unit, and configured to measure a flow rate of the gas passing through the gas valve unit.

In this case, the gas valve unit may include: a flow rate adjusting unit including: a ball housing having the hollow space; a ball member rotatably provided in the ball housing and having a fluid flow path along a central axis; a rotational drive member configured to rotate the ball member; a drive means configured to operate the rotational drive member; and valve seat members disposed in the ball housing so as to face each other with the ball member interposed therebetween; and a flow blocking unit inserted toward a center of the ball housing from one side of the gas valve unit which is one of the two sides of the gas valve unit and connected to the gas supply source.

In this case, the flow blocking unit may include: a main body assembled inside one side of the ball housing; a valve seat insertion portion formed at one end of the main body so that a part of one of the valve seat members, which is adjacent to the gas supply source, is inserted; and a fuse insertion portion formed at the other end of the main body so that a fuse member for temporarily closing the fluid flow path in the ball member is positioned at a rear end of the valve seat insertion portion.

In this case, the flow blocking unit may have an outer peripheral shape and a length corresponding to an internal shape at one side of the ball housing.

Meanwhile, the flow rate sensor unit may include: a flow rate sensor; a flow rate sensor cover body configured to surround the flow rate sensor; and a flow rate sensor support body having a seating portion having a shape corresponding to an outer peripheral shape of the flow rate sensor cover body so that the flow rate sensor cover body is mounted.

Further, a method of assembling the gas fuse cock embedded with the flow rate sensor according to the present invention may include inserting a first valve seat, the ball member, and the flow blocking unit into the ball housing in this order in a direction from the gas appliance to the gas supply source, in which a second valve seat is inserted into one side of the flow blocking unit facing the ball member, and the flow blocking unit is inserted into the ball housing in a state in which the fuse member is inserted into the other side of the flow blocking unit.

Further, an automatic gas safety shut-off device including a gas fuse cock embedded with a flow rate sensor according to the present invention may include: the gas fuse cock embedded with the flow rate sensor; a controller configured to determine timing of closing the rotational drive member and generate a signal for rotating the drive means; and a cover frame having the controller and configured to receive the gas fuse cock.

### Advantageous Effects

The gas fuse cock embedded with the flow rate sensor and the automatic gas safety shut-off device having the same according to the present invention, which are provided to achieve the above-mentioned objects, have the following effects.

According to the present invention, the flow rate sensor is formed to be integrally coupled to the fuse cock, such that the assembly structure is simple, and the number of components is decreased, thereby greatly reducing difficulty of the work, and thus reducing required manpower and personnel expenses.

In addition, according to the structure of the present invention, it is possible to minimize damage to the respective constituent elements during the process of detaching the respective constituent elements, such that it is easy to reuse the constituent elements.

In addition, according to the present invention, there is no seam between the respective constituent elements, such that it is possible to perfectly prevent leakage of gas.

In addition, according to the present invention, it is possible to detect leakage of gas by using the IoT-based sensor network and to safely, quickly, and remotely block the gas in a dangerous situation.

In addition, according to the present invention, the limitation of the size and installation of the gas flow rate detecting means is eliminated, such that it is possible to provide expandability of functions of products, ease of installation, and design flexibility.

In addition, according to the present invention, it is possible to provide convenience to the user by employing various auxiliary functions such as remote control and earthquake detection.

In addition, according to the present invention, whether the usage of the gas by the gas appliance is stopped, whether the gas fuse cock is left unattended, whether the gas fuse cock is used over a long period of time, and whether the gas leaks are determined based on the detected gas flow rate, and the valve is automatically closed, thereby preventing a gas safety accident and providing convenience to the user.

The effects of the present invention are not limited to the aforementioned effects, and other effects, which are not mentioned above, will be clearly understood by those skilled in the art from the claims.

### DESCRIPTION OF DRAWINGS

FIG. 1 is an exploded cross-sectional view illustrating a gas valve device in the related art.

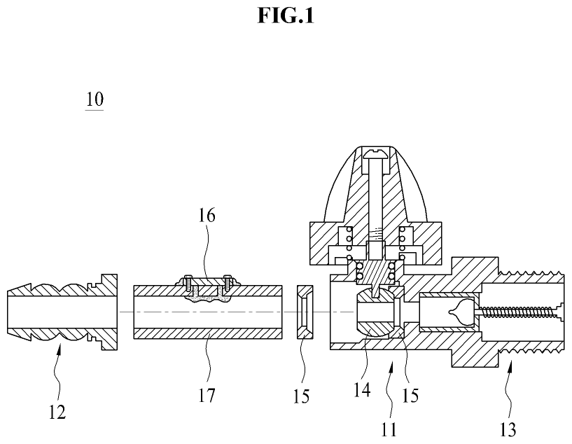

FIG. 2 is a perspective view illustrating a state in which a cover covers the gas valve device in the related art.

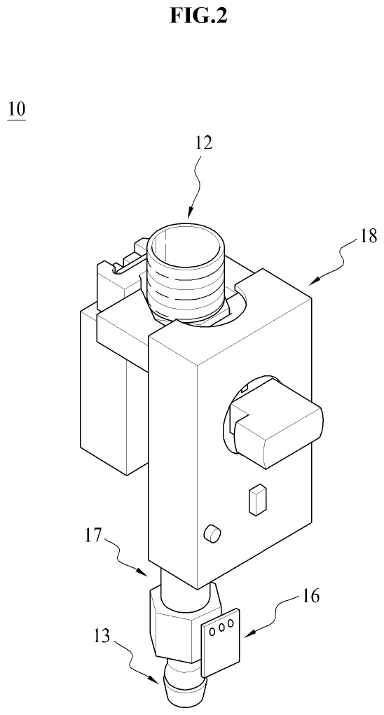

FIG. 3 is an exploded cross-sectional view illustrating a gas fuse cock embedded with a flow rate sensor according to the present invention.

FIG. 4 is a coupled cross-sectional view illustrating the gas fuse cock embedded with the flow rate sensor according to the present invention.

FIG. 5 is a flowchart illustrating a method of manufacturing the gas fuse cock embedded with the flow rate sensor according to the present invention.

FIG. 6 is a perspective view illustrating a state in which a cover covers the gas fuse cock embedded with the flow rate sensor according to the present invention.

FIG. 7 is a rear view illustrating a state in which the cover covers the gas fuse cock embedded with the flow rate sensor according to the present invention.

### BEST MODE

A gas fuse cock embedded with a flow rate sensor according to an exemplary embodiment of the present invention may include: a gas valve unit formed in the form of a housing having a hollow space, having one side connected to a gas supply source, and configured to control a flow of gas; and a tubular flow rate sensor unit having one side connected to a gas appliance, injection-molded integrally with the gas valve unit so as to extend from the other side of the gas valve unit, and configured to measure a flow rate of the gas passing through the gas valve unit.

### MODE FOR INVENTION

Hereinafter, exemplary embodiments of the present invention for specifically accomplishing the objects of the present invention will be described with reference to the accompanying drawings. In the description of the present exemplary embodiments, like terms and like reference numerals are used for like configurations, and additional descriptions for the like configurations will be omitted.

In addition, in the description of the present exemplary embodiment, the configurations illustrated in the drawings are just examples for helping to understand the detailed description, but not intended to limit the scope of the present invention.

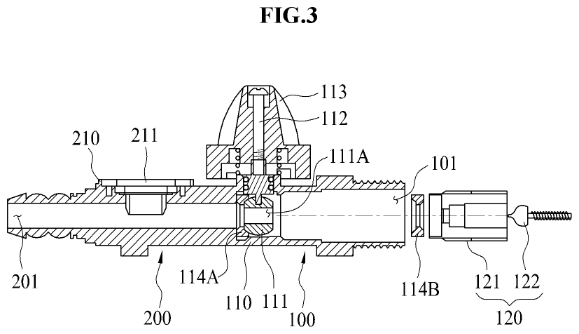

As illustrated in FIGS. 3 to 6, according to a gas fuse cock embedded with a flow rate sensor and an automatic gas safety shut-off device having the same according to exemplary embodiments of the present invention, a gas valve unit 100 and a flow rate sensor unit 200 are integrally formed, thereby minimizing the probability of leakage of gas and reducing an overall size of the gas fuse cock mounted with a cover body.

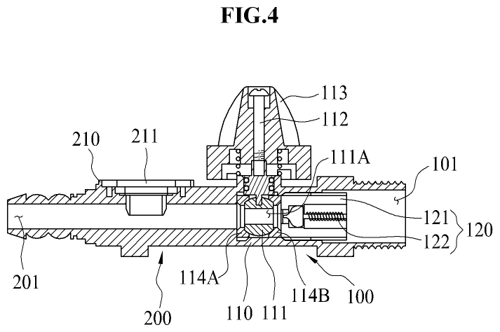

First, FIG. 3 illustrates a state in which constituent elements of the gas fuse cock embedded with the flow rate sensor according to the present invention are disassembled, and FIG. 4 illustrates a state in which the gas fuse cock embedded with the flow rate sensor according to the present invention is assembled.

As illustrated in FIG. 3, the gas fuse cock embedded with the flow rate sensor according to the exemplary embodiment of the present invention has the gas valve unit 100 and the flow rate sensor unit 200.

First, the gas valve unit 100 is configured to supply gas, which is introduced to one side from a gas supply source, to a gas appliance connected to the other side of the gas valve unit 100.

The gas valve unit 100 includes a ball housing 110 formed in the form of a housing having a hollow space. Constituent elements for controlling a flow of gas may be installed in the ball housing 110.

A ball member 111 is rotatably provided in the ball housing 110 and has a fluid flow path along a central horizontal axis. Further, the gas valve unit 100 may include a rotational drive member 112 configured to rotate the ball member 111, a drive means 113 configured to operate the rotational drive member 112, and valve seat members 114A and 114B disposed in the ball housing 110 so as to face each other with the ball member 111 interposed therebetween.

In this case, except for the ball housing 110, the components of the gas valve unit 100 may be identical to the components of the gas valve in the related art.

Specifically, a flow rate adjusting unit, which has the ball member 111, the rotational drive member 112, and the drive means 113 and is identical to the flow rate adjusting unit of the ball valve in the related art, may be applied in the ball housing 110 of the gas valve unit 100 in which the gas flows.

The ball member 111 typically has a spherical shape having a predetermined diameter and is horizontally penetrated by the fluid flow path having a predetermined diameter so that the gas may flow through the fluid flow path.

Therefore, when a passageway through which the gas flows in the ball housing 110 and the fluid flow path in the ball member 111 is positioned along the same axis, the gas may smoothly flow. Further, when the rotational drive member 112 is manipulated by the drive means 113 such that the ball member 111 is rotated by 90 degrees, the gas flow passageway in the ball housing 110 is closed, such that the supply of gas is shut off.

In this case, the valve seat members 114A and 114B, which are disposed to face each other with the ball member 111 interposed therebetween, are made of Teflon which is fluoride resin excellent in rust resistance, thermal insulation, and electrical properties. The valve seat members 114A and 114B block an electric current flowing along the ball housing 110, maintain leakproof sealability of the ball member 111, and support the ball member 111 so that a position of the ball member 111 does not easily deviate.

Further, a flow blocking unit 120 is provided at a side of the gas inlet port 101 of the gas valve unit 100 in order to prevent an overflow of the gas, thereby controlling a flow pressure of the gas in accordance with a preset reference.

The flow blocking unit 120 is inserted toward the center of the ball housing 110 from one side of the gas inlet port 101, which is one of the two sides of the gas valve unit 100 and connected to the gas supply source. When the gas at excessive pressure flows in the state in which the fluid flow path is opened by the ball member 111, the flow blocking unit 120 serves to temporarily block an outflow of the gas.

The flow blocking unit 120 includes a main body 121 assembled inside one side of the ball housing 110, and a valve seat insertion portion 121A and a fuse insertion portion 121B which are formed at both sides of the main body 121.

The valve seat insertion portion 121A is formed at one end of the main body 121 so that a part of the valve seat member 114B of the valve seat members 114A and 114B, which is adjacent to the gas supply source, is inserted.

Further, the fuse insertion portion 121B is formed at a rear end of the valve seat insertion portion 121A so that a fuse member 122 for temporarily closing the fluid flow path in the ball member 111 is inserted.

The fuse member 122 is not operated when the flow of the gas normally flows in the state in which the fluid flow path in the ball member 111 is fully opened, thereby allowing the gas to be stably supplied.

However, when the gas is excessively discharged at a predetermined pressure or higher due to separation of or damage to a hose in order to intentionally discharge the gas in the state in which the fluid flow path in the ball member 111 is fully opened, the fuse member 122 is pushed toward the gas outlet port 201 by the pressure of the gas.

Therefore, the fuse member 122 operates to block one side of the fluid flow path in the ball member 111 and automatically shuts off the supply of the gas, thereby preventing the gas from being excessively discharged and leaked. A fuse member in the related art may be adopted as the fuse member 122.

Consequently, the flow blocking unit 120 is characterized by having an outer peripheral shape and a length corresponding to an internal shape at one side of the ball housing 110, such that the flow blocking unit 120 may be assembled and mounted in the ball housing 110.

Therefore, the valve seat member 114B and the fuse member 122 may be mounted and separated at one time, thereby ensuring convenience and safety in replacing the valve seat member 114B and the fuse member 122 in case of breakdown.

Next, one side of the flow rate sensor unit 200 is connected to the gas appliance, and the flow rate sensor unit 200 is injection-molded integrally with the gas valve unit so that the flow rate sensor unit 200 extends from the other side of the gas valve unit. The flow rate sensor unit 200 has a tubular shape to measure a flow rate of the gas passing through the gas valve unit 100.

The flow rate sensor unit 200 has a flow rate sensor (not illustrated) configured to measure the flow rate of the gas. Since the flow rate sensor unit 200 is integrally formed at one side of the gas valve unit 100, the flow rate sensor unit 200 has a gas outlet port 201 through which the gas introduced through the gas inlet port 101 is discharged.

Meanwhile, the flow rate sensor may be installed on the flow rate sensor unit 200 by being mounted in a flow rate sensor cover body 212 that surrounds the flow rate sensor.

Therefore, the flow rate sensor unit 200 includes a flow rate sensor support body 210 having a seating portion 211 having a shape corresponding to an outer peripheral shape of the flow rate sensor cover body 212 so that the flow rate sensor cover body 212 is mounted.

The ball housing 110 of the gas valve unit 100 and the flow rate sensor support body 210 of the flow rate sensor unit 200, which are configured as described above, are integrally injection-molded such that the separated constituent elements may be mounted at predetermined positions.

That is, the respective constituent elements of the gas fuse cock embedded with the flow rate sensor according to the present invention may be sequentially positioned in the preset order in the direction from the gas appliance to the gas supply source.

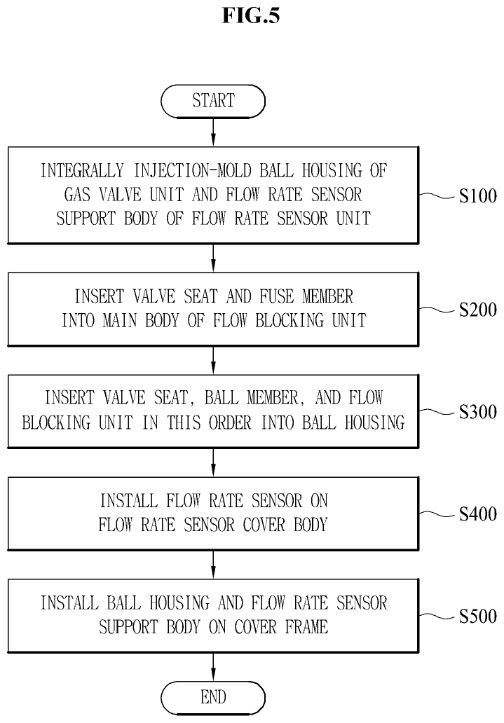

Hereinafter, a method of assembling the gas fuse cock embedded with the flow rate sensor according to the present invention will be described with reference to FIG. 5.

First, in order to assemble the gas fuse cock embedded with the flow rate sensor according to the present invention, a step S100 of integrally injection-molding the ball housing 110 of the gas valve unit 100 and the flow rate sensor support body 210 of the flow rate sensor unit 200 is essentially required.

In this case, the ball housing 110 and the flow rate sensor support body 210 are integrally injection-molded so as to have a tubular shape opened at ends thereof and having a hollow portion therein. The ball housing 110 and the flow rate sensor support body 210 may be machined to have a specific shape so that the flow blocking unit 120, the flow rate adjusting unit, and the flow rate sensor cover body may be installed.

Specifically, one side of the gas valve unit 100, which is to be connected to the gas supply source, may have a screw thread and thus be connected to the gas supply source, and one side of the flow rate sensor unit 200, which is to be connected to the gas appliance, may have an external appearance having a corrugated portion to be inserted into the hose of the gas appliance.

Further, the interior at one side of the gas valve unit 100 has a shape corresponding to the external appearance of the flow blocking unit 120, and the ball housing 110 is formed at the other side of the gas valve unit 100 so that the flow rate adjusting unit may be mounted in the ball housing 110.

In addition, the other side of the gas valve unit 100 and one side of the flow rate sensor unit 200 are integrally attached to each other, and a hole having a shape corresponding to the external shape of the flow rate sensor cover body 210 may be formed so that the flow rate sensor may be mounted on a part of the flow rate sensor unit 200.

The gas fuse cock according to the present invention, which has the integrated body as described above, may be installed between the gas supply source and the gas appliance, specifically, in the order of the gas supply source—the gas valve unit 100—the flow rate sensor unit 200—the gas appliance.

That is, the gas valve unit 100 and the flow rate sensor unit 200 are integrally formed, and the first valve seat 1114A, the ball member 111, and the flow blocking unit 120 are inserted into the ball housing 110 in this order in the direction from the gas supply source to the gas appliance.

In this case, before the flow blocking unit 120 is inserted into one side of the ball housing 110, the second valve seat 114B is inserted into one side of the main body 121 facing the ball member 111, and then the flow blocking unit 120 may be inserted into the ball housing 110 in the state in which the fuse member 122 is inserted into the other side of the flow blocking unit 120 (S200).

Therefore, the constituent elements are positioned in the ball housing 110 in the order of the valve seat 114A—the ball member 111—the flow blocking unit 120 (S300).

Further, the rotational drive member 112 and the drive means 113, which are configured to operate the inserted ball member 111, may be exposed out of the ball housing 110 so that the user may manipulate the rotational drive member 112 and the drive means 113.

Next, in order to install the flow rate sensor on the flow rate sensor unit 200, the flow rate sensor may be installed on the flow rate sensor cover body first (S400) and then mounted in the hole which is formed in advance in the flow rate sensor unit 200 and has the shape corresponding to the external shape of the flow rate sensor cover body 210.

Lastly, the ball housing 110 and the flow rate sensor support body 210 of the gas fuse cock embedded with the flow rate sensor according to the present invention, which are assembled by the above-mentioned assembling method may be installed to be received in a cover frame 300 of the automatic gas safety shut-off device according to the present invention (S500).

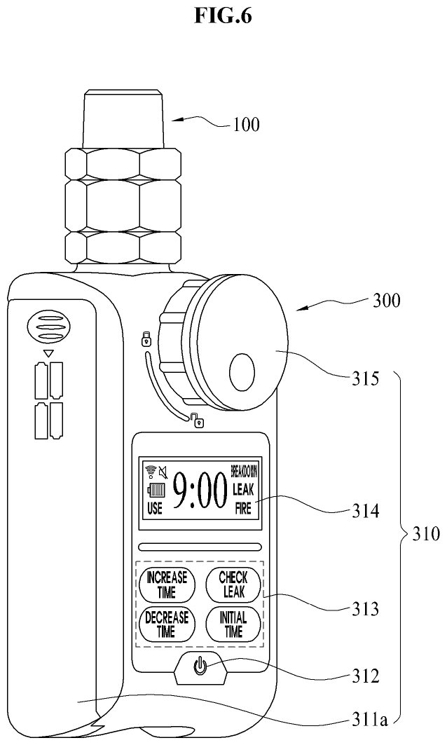

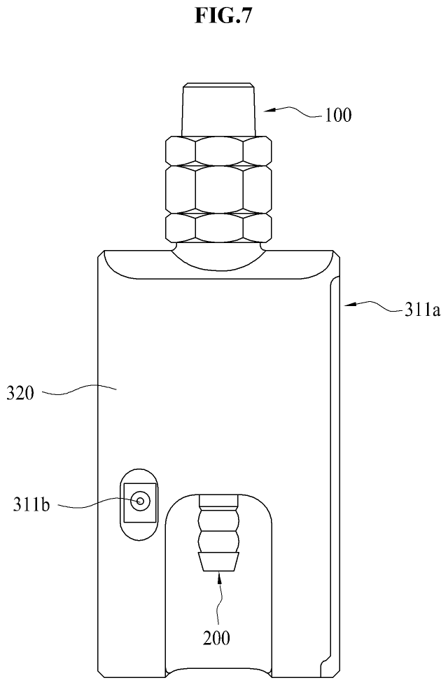

The automatic safety shut-off device configured to automatically control the gas fuse cock embedded with the flow rate sensor according to the present invention assembled by the above-mentioned method and to protect an external shape of the gas fuse cock will be described with reference to FIGS. 6 and 7.

FIG. 6 is a perspective view illustrating a state in which a cover covers the gas fuse cock embedded with the flow rate sensor according to the present invention, and FIG. 7 is a rear view illustrating a state in which the cover covers the gas fuse cock embedded with the flow rate sensor according to the present invention.

The automatic gas safety shut-off device 300 according to the present invention may include a cover frame 320 having a controller 310 that determines the closing timing of the rotational drive member 112 of the gas fuse cock embedded with the flow rate sensor and generates a signal for rotating the drive means 113.

First, the controller 310 is connected to the gas fuse cock and configured to automatically control the gas fuse cock. As illustrated in FIG. 6, the controller 310 may include a power supply unit 311a, a power control unit 312, a status control unit 313, a status display unit 314, and a manipulation dial unit 315.

First, the power supply unit 311a is configured to provide power for operating the automatic gas safety shut-off device 300, and for example, a wireless power supply source such as a battery may be used as the power supply unit 311a.

In this case, in a case in which the power supply unit 311a supplies power in a wireless manner, the power supply unit 311a may be detachably coupled to an outer casing, and as a result, the user may advantageously and easily replace the battery that reached the end of the lifetime.

Further, since the wireless power supply source is embedded, the automatic gas safety shut-off device may be continuously used by being supplied with power from the wireless power supply source even in case of power failure.

Meanwhile, as illustrated in FIG. 7, the automatic gas safety shut-off device may include a connector 311b connected to an external gas detector.

When the automatic gas safety shut-off device 300 is supplied with the required power from the power supply unit 311a as described above, whether to operate the automatic gas safety shut-off device 300 may be selectively controlled by the power control unit 312.

The power control unit 312 is a typical means for power on-off control, and a detailed description thereof will be omitted.

Next, the status control unit 313 may control the timing of opening and closing the ball member 111 and check whether the gas leaks.

Specifically, the status control unit 313 may include an initial time button capable of setting the initial time at which the gas begins to be used, and the status control unit 313 may include an increase time button and a decrease time button in order to set the time for which the gas is used from the initial time.

For example, assuming that the current time is 7 and the moment when the gas begins to be used is set as 7:10 by the initial time button, the drive means 113 rotates at 7:10, such that the fluid flow path of the ball member 111 is opened.

Further, in a case in which it takes 15 minutes from 7:10 to the moment when the use of the gas is ended, the duration of use of the gas may be set by the increase time button and the decrease time button. That is, the time for which the fluid flow path in the ball member 111 is opened may be set.

Therefore, assuming that a basic position of the drive means 113 is a position at which the flow of the gas is blocked, when 15 minutes set by the user has elapsed, the drive means 113, which rotates to the position at which the flow of the gas is allowed from 7:10, rotates to the original position again, such that the fluid flow path of the ball member 111 may be closed, and the flow of the gas may be blocked.

In this case, when the gas flame is turned off even though 15 minutes set by the user has not elapsed, the flow rate sensor detects this and the set time is automatically changed by about 10 seconds, and the drive means 113 may be automatically rotated to a gas blocking position.

Further, the status display unit 314 is configured to display information operated by the status control unit 313 and status information such as a lifespan of the battery, a connection status, time, and whether the gas leaks so that the user may ascertain the information with the naked eye.

Therefore, the status display unit 314 determines the lifespan of the battery of the power supply unit 311a and notifies the user of the timing of replacing the battery with a warning signal. When it is detected that a voltage outputted from the flow rate sensor is different from a reference voltage, the status display unit 314 notifies this with a warning signal. The status display unit 314 may control and close the ball member 111 after the set usage time has elapsed. As the warning signal, alarm sound, which may be recognized by the user, may be transmitted, or warning information may be transmitted in such a way that the corresponding letter is formed and flickers.

Lastly, the manipulation dial unit 315 is configured to enable the user to optionally control whether to rotate the drive means 113.

Therefore, the user may select to allow the supply of the gas by manually operating the manipulation dial unit 315, without separately setting the time, at the moment when the automatic gas safety shut-off device is required to be used and at the moment when the automatic gas safety shut-off device need not be used.

In addition, the manipulation dial unit 315 has markers that enables the user to recognize locking and unlocking, such that it is possible to check whether the current driving means 113 is in an opened or closed state. Therefore, the user may control the rotational position of the manipulation dial unit 315 so that the ball member 111 is not left unattended in the opened state.

Further, the cover frame 320 is configured to protect the gas fuse cock embedded with the flow rate sensor and the controller according to the present invention.

The cover frame 320 serves to surround the flow rate adjusting unit and the flow rate sensor support body 210 so that the gas inlet port 101 and the gas outlet port 201 are exposed to the outside. The drive means 113 is mounted in the manipulation dial unit 315 so that the drive means 113 may be rotated by the manipulation dial unit 315.

In this case, an end of the gas outlet port 201 is positioned in a receiving space formed in the cover frame 320 so that the coupling portion with the gas appliance may not be exposed to the outside. Therefore, it is possible to prevent the gas outlet port 201 from being arbitrarily withdrawn from the gas appliance.

In addition, the automatic gas safety shut-off device including the gas fuse cock embedded with the flow rate sensor according to the present invention receives situation information about whether the gas is detected and whether the gas leaks, and transmits information for remotely controlling the blockage of the gas valve as corresponding information in accordance with the status of the corresponding region in accordance with the detection of the gas and the leakage of the gas, thereby detecting the gas and remotely controlling the region in which the gas leaks through the Internet of Things (IoT).

That is, the automatic gas safety shut-off device according to the present invention detects the flow and heat of the gas by using the flow rate sensor as well as the timer function, and the artificial intelligence flow rate sensor automatically locks the valve to shut off the supply of gas in a dangerous situation such as non-use of the gas, malfunction, leakage of gas, and a fire.

Therefore, when the ambient temperature is equal to or higher than 70 degrees, this may be recognized as a fire, such that the gas is automatically shut off while a fire alarm is generated to prevent explosion. When the user easily checks whether the gas leaks and then manipulates the button once, the supply of the gas may be automatically shut off within 10 seconds in a dangerous situation.

In addition, when the gas leaks minutely, the sensor detects the leakage of the gas and automatically rotates the ball member 111 while generating the alarm sound at the same time, such that safety against a gas accident may be ensured. Moreover, wireless communication is used in conjunction with the IoT technology, and the user may ascertain the state of the gas flame with smartphone applications, thereby implementing remote control.

That is, the gas fuse cock embedded with the flow rate sensor and the automatic gas safety shut-off device having the same according to the present invention may detect leakage of gas and safely and quickly shut off the gas in a dangerous situation by using the IoT-based sensor network.

Furthermore, the gas fuse cock embedded with the flow rate sensor and the automatic gas safety shut-off device having the same according to the present invention may include an earthquake detecting sensor, and may shut off the gas when vibration of a predetermined reference value or higher is detected.

Meanwhile, the exemplary embodiments of the present invention are disclosed in the present specification and the drawings, and specific terms are used, but the specific terms are used as general meanings merely for easily explaining the technical contents of the present invention and helping understand the present invention, but not intended to limit the scope of the present invention. It is obvious to those skilled in the art to which the present invention pertains that other modified embodiments may be carried out based on the technical spirit of the present invention in addition to the exemplary embodiments disclosed herein.

### INDUSTRIAL APPLICABILITY

The present invention relates to a gas fuse cock embedded with a flow rate sensor and an automatic gas safety shut-off device having the same, in which the flow rate sensor is mounted to reduce leakage of gas without a separate connecting component.

1. A gas fuse cock embedded with a flow rate sensor, the gas fuse cock comprising:
a gas valve unit formed in the form of a housing having a hollow space, having one side connected to a gas supply source, and configured to control a flow of gas; and
a tubular flow rate sensor unit having one side connected to a gas appliance, injection-molded integrally with the gas valve unit so as to extend from the other side of the gas valve unit, and configured to measure a flow rate of the gas passing through the gas valve unit.

2. The gas fuse cock of claim 1, wherein the gas valve unit comprises:
a flow rate adjusting unit comprising:
a ball housing having the hollow space;
a ball member rotatably provided in the ball housing and having a fluid flow path along a central axis;
a rotational drive member configured to rotate the ball member;
a drive means configured to operate the rotational drive member; and
valve seat members disposed in the ball housing so as to face each other with the ball member interposed therebetween; and
a flow blocking unit inserted toward a center of the ball housing from one side of the gas valve unit which is one of the two sides of the gas valve unit and connected to the gas supply source.

3. The gas fuse cock of claim 2, wherein the flow blocking unit comprises:
a main body assembled inside one side of the ball housing;
a valve seat insertion portion formed at one end of the main body so that a part of one of the valve seat members, which is adjacent to the gas supply source, is inserted; and
a fuse insertion portion formed at the other end of the main body so that a fuse member for temporarily closing the fluid flow path in the ball member is positioned at a rear end of the valve seat insertion portion.

4. The gas fuse cock of claim 2, wherein the flow blocking unit has an outer peripheral shape and a length corresponding to an internal shape at one side of the ball housing.

5. The gas fuse cock of claim 1, wherein the flow rate sensor unit comprises:
a flow rate sensor;
a flow rate sensor cover body configured to surround the flow rate sensor; and
a flow rate sensor support body having a seating portion having a shape corresponding to an outer peripheral shape of the flow rate sensor cover body so that the flow rate sensor cover body is mounted.

6. A method of assembling the gas fuse cock embedded with the flow rate sensor according to claim 1, the method comprising:
inserting a first valve seat, the ball member, and the flow blocking unit into the ball housing in this order in a direction from the gas appliance to the gas supply source,
wherein a second valve seat is inserted into one side of the flow blocking unit facing the ball member, and the flow blocking unit is inserted into the ball housing in a state in which the fuse member is inserted into the other side of the flow blocking unit.

7. An automatic gas safety shut-off device comprising:
the gas fuse cock embedded with the flow rate sensor according to claim 1;
a controller configured to determine timing of closing the rotational drive member and generate a signal for rotating the drive means; and
a cover frame having the controller and configured to receive the gas fuse cock.

8. The automatic gas safety shut-off device of claim 7, wherein the gas valve unit comprises:
a flow rate adjusting unit comprising:
a ball housing having the hollow space;
a ball member rotatably provided in the ball housing and having a fluid flow path along a central axis;
a rotational drive member configured to rotate the ball member;
a drive means configured to operate the rotational drive member;
valve seat members disposed in the ball housing so as to face each other with the ball member interposed therebetween; and
a flow blocking unit inserted toward a center of the ball housing from one side of the gas valve unit which is one of the two sides of the gas valve unit and connected to the gas supply source.

9. The automatic gas safety shut-off device of claim 8, wherein the flow blocking unit comprises:
a main body assembled inside one side of the ball housing;
a valve seat insertion portion formed at one end of the main body so that a part of one of the valve seat members, which is adjacent to the gas supply source, is inserted; and
a fuse insertion portion formed at the other end of the main body so that a fuse member for temporarily closing the fluid flow path in the ball member is positioned at a rear end of the valve seat insertion portion.

10. The automatic gas safety shut-off device of claim 8, wherein the flow blocking unit has an outer peripheral shape and a length corresponding to an internal shape at one side of the ball housing.

11. The automatic gas safety shut-off device of claim 1, wherein the flow rate sensor unit comprises:
a flow rate sensor;
a flow rate sensor cover body configured to surround the flow rate sensor; and
a flow rate sensor support body having a seating portion having a shape corresponding to an outer peripheral shape of the flow rate sensor cover body so that the flow rate sensor cover body is mounted.
